(19) United States
(12) Patent Application Publication
(10) Pub. No.: US 2015/0127615 A1
(43) Pub. Date: May 7, 2015

(54) DATA BACKUP METHOD AND SYSTEM

(71) Applicant: Beijing Netqin Technology Co., Ltd., Beijing (CN)

(72) Inventors: Tao Liang, Beijing (CN); Lin Cheng, Beijing (CN); Zheng Zhao, Beijing (CN); Ping Cheng, Beijing (CN)

(21) Appl. No.: 14/415,415

(22) PCT Filed: Mar. 14, 2013
(86) PCT No.: PCT/CN2013/072606

§ 371 Date: Jan. 16, 2015

(30) Foreign Application Priority Data
Jul. 30, 2012 (CN) 201210268471.1

(51) Int. Cl. G06F 11/14

(52) U.S. Cl. CPC G06F 11/1451; G06F 2201/80
USPC 707/654

(57) ABSTRACT

The present disclosure provides a data backup method, comprising: A. receiving a data type of data which is selected by a user to be backed up; B. calculating a first capacity of data having the same data type, detecting a residual user second capacity on a server side, and comparing the first capacity with the second capacity, wherein if the first capacity is greater than the second capacity, the backup process is interrupted, and if the first capacity is not greater than the second capacity, step C is performed; and C. encrypting and uploading the data to be backed up to a database on the server side for backup, and displaying a backup result after the backup is completed. With the present disclosure, important data can be directly backed up by the mobile terminal to the server side, thereby not only occupying less local storage space of the mobile terminal, but also better protecting the important data from being lost, which greatly meets users' requirements for security.

### CROSS-REFERENCE TO RELATED APPLICATION(S)

This application is a U.S. National Phase application of International Application No. PCT/CN2013/072606, filed on Mar. 14, 2013, entitled “DATA BACKUP METHOD AND SYSTEM,” which claims priority to Chinese Application No. 201210268471.1, filed on Jul. 30, 2012, both of which are incorporated herein by reference in their entirety.

### TECHNICAL FIELD

The present disclosure relates to the field of mobile terminals, and in particular, to a data backup method and system.

### BACKGROUND

With the frequent use of mobile terminals, such as smart phones, tablets, etc., people increasingly rely on them. A large amount of personal secret information is stored in these mobile terminals, and if the important data is lost due to the theft or missing of the mobile phones or computers or due to user's incorrect operations, the user has to pay for it. Currently, many people come to realize the potential threats and serious consequences resulting from the data loss, and therefore they pay more and more attention to data backup.

### SUMMARY

In view of above, an object of the present disclosure is to provide a data backup method and system for providing mobile terminal data with a back up method, thereby satisfying users' requirements for security.

The present disclosure provides a data backup method comprising:

A. receiving a data type of data which is selected by a user to be backed up;

B. calculating a first capacity of data having the same data type, detecting a second residual user capacity on a server side, and comparing the first capacity with the second capacity, wherein if the first capacity is greater than the second capacity, the backup process is interrupted, and if the first capacity is not greater than the second capacity, step C is performed; and

C. encrypting and uploading the data to be backed up to a database on the server side for backup, and displaying a backup result after the backup is completed.

According to the above method, the data type comprises any one of image, video, short message, call record, and personal contact, or any combination thereof, and wherein a personal contact comprises a contact name, a telephone number, and a personal incoming call processing manner.

According to the above method, the server side receives an instruction of requesting for data backup from the mobile terminal, and receives data uploaded by the mobile terminal.

According to the above method, the method further comprises: after the backup process is interrupted, if the user chooses to continue the backup, continuing the backup from a point where the data has been backed up.

According to the above method, the method further comprises: processing, by the server side, the uploaded data to be backed up by:

combining, de-duplicating, encrypting, and storing data having the image type and/or the video type; and

unpacking, combining, de-duplicating, packing, encrypting, and storing data having the short message type, the call record type, and/or the personal contact type.

The present disclosure provides a data backup system comprising a display module, the system further comprising: a mobile terminal comprising an acquisition module, a calculation and processing module, and an encryption and upload module; and a server side comprising a database, wherein

the acquisition module is configured to receive a data type of data which is selected by a user to be backed up;

the calculation and processing module is configured to calculate a first capacity of data having the same data type, configured to detect a second residual user capacity on the server side, and configured to compare the first capacity with the second capacity, wherein if the first capacity is greater than the second capacity, the backup process is interrupted, and if the first capacity is not greater than the second capacity, a backup operation is performed by the encryption and upload module; and

the encryption and upload module is configured to encrypt and upload the data to be backed up to the database on the server side for backup;

the display module is configured to display a backup result after the backup is completed; and

the database is configured to store the data to be backed up.

According to the above system, the data type comprises any one of image, video, short message, call record, and personal contact, or any combination thereof, and a personal contact comprises a contact name, a telephone number, and a personal incoming call processing manner.

According to the above system, the server side comprises a communication module configured to receive an instruction of requesting for data backup from the mobile terminal, and configured to receive data uploaded by the mobile terminal.

According to the above system, the system is further configured to continue the backup from a point where the data has been backed up if the user chooses to continue the backup after the backup process is interrupted.

According to the above system, the server side further comprises a processing module configured to process the uploaded data to be backed up by:

combining, de-duplicating, encrypting, and storing data having the image type and/or the video type; and

unpacking, combining, de-duplicating, packing, encrypting, and storing data having the short message type, the call record type, and/or the personal contact type.

With the data backup method and system according to the present disclosure, important data can be directly backed up by a mobile terminal to a server side, thereby not only occupying less local storage space of the mobile terminal, but also better protecting the important data from being lost, which greatly meets users' requirements for security.

### BRIEF DESCRIPTION OF THE DRAWINGS

In order to illustrate technical solutions in embodiments of the present disclosure or in the prior art more clearly, drawings needed to be used in the description of the embodiments or the prior art will be described below in brief. Obviously, the drawings described below are merely some embodiments of the present disclosure. Those ordinarily skilled in the art can further contemplate other drawings from these drawing without any inventive efforts. In the drawings:

FIG. 1 is a flowchart of a data backup method according to an embodiment of the present disclosure;

FIG. 2 is a diagram of a display interface of a mobile terminal according to an embodiment of the present disclosure;

FIG. 3 is a flowchart of a data backup operation for a mobile terminal according to an embodiment of the present disclosure; and

FIG. 4 is a block diagram of a data backup system for a mobile terminal according to an embodiment of the present disclosure.

### DETAILED DESCRIPTION

In order to make the objects, technical solutions and advantages of the present disclosure more clear, embodiments of the present disclosure will be further described in detail below in conjunction with accompanying drawings. The illustrative embodiments of the present disclosure and the description thereof are used to explain the present disclosure, instead of limitations to the present disclosure.

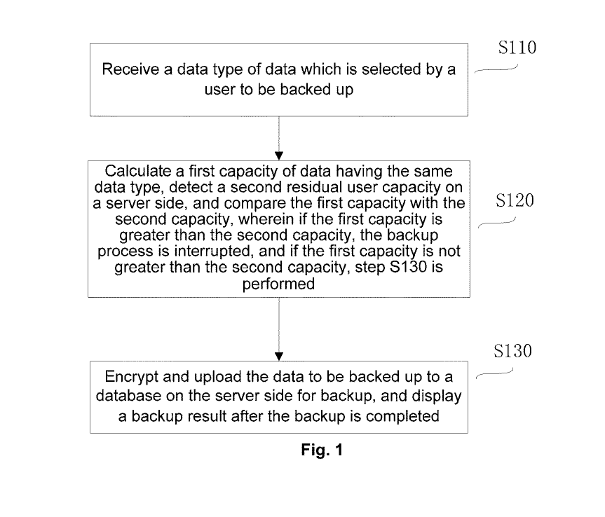

With reference to FIG. 1, illustrated is a data backup method according to an embodiment of the present disclosure, the method comprising following steps.

Step S110: a data type of data which is selected by a user to be backed up is received.

Step S120: a first capacity of data having the same data type is calculated, a second residual user capacity on a server side is detected, and the first capacity is compared with the second capacity. If the first capacity is greater than the second capacity, then the backup process is interrupted, and if the first capacity is not greater than the second capacity, step S130 is performed.

Step S130: the data to be backed up is encrypted and uploaded to a database on the server side for backup, and a backup result is displayed after the backup is completed.

In this embodiment, the use of the above data backup method on users' personal information takes precedence. That is, the backup function can only be used after a user is authorized and properly logs in.

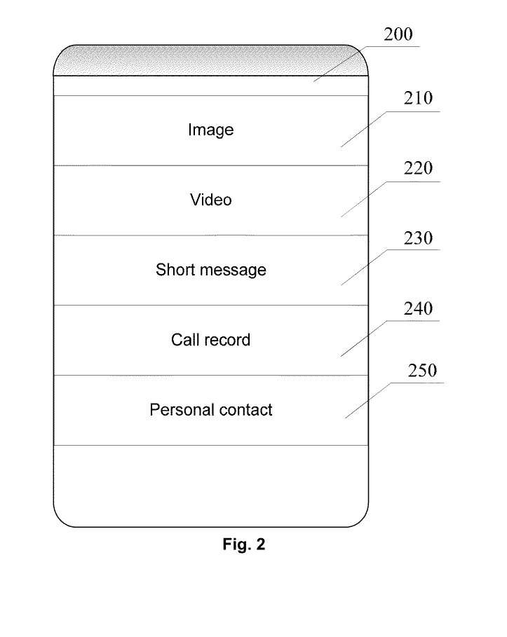

With reference to FIG. 2, illustrated is a diagram of a display interface of a mobile terminal according to an embodiment of the present disclosure. The mobile terminal could be any device, which includes but not limited to a mobile phone, a tablet, a notebook computer, etc. There are several options on a display interface 200, such as 210, 220, 230, 240, and 250, etc. Data types represented by these options comprise but not limited to image, video, short message, call record, and/or personal contact, etc. Content of a file having the image type includes the image file per se, as well as a file name, an original path, time attributes, and/or tag attributes, etc.; content of a file having the video type includes the video file per se, as well as a file name, an original path, time attributes, and/or tag attributes, etc.; content of a file having the short message type includes a telephone number, short message content, a short message type (transmission or reception), and/or a transmission or reception time, etc.; content of a file having the call record type includes a telephone number, a type (an incoming call, an outgoing call, a missed call, a rejected call, and/or a rejection manner), time, and/or a duration, etc.; and content of a file having the personal contact type includes a contact name, a telephone number(s), and/or a personal incoming call processing manner.

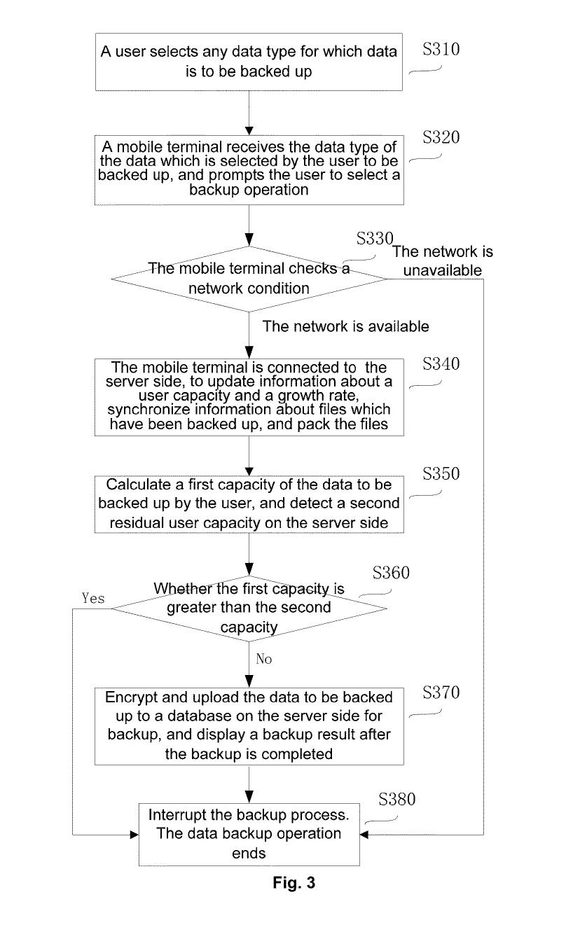

With reference to FIG. 3, when a user needs to perform a data backup on data corresponding to any option on the display interface 200, a flow of a data backup operation according to an embodiment of the present disclosure is described as follows.

Step S310: data type options, for which data backup can be performed, is displayed on the display interface 200, and a user selects any data type for which data is to be backed up. The user may click the data type options by using a mouse, a keyboard, a touch screen, etc. During the selection process, the user can only select the types, rather than a single picture, a single video, a single contact, or a single short message, etc.

In the present embodiment, the backup function has a setting option, which may be used by the user to modify data types for backup or to set whether the selection of the data types for backup are prompted every time the data is to be backed up.

Step S320: the mobile terminal receives the data type of the data which is selected by the user to be backed up, and the user is prompted to select a backup operation.

It should be noted that before an operation of backing up local data to a server side, the mobile terminal needs to perform some steps of detection and calculation to ensure that the data is rapidly and accurately backed up.

Step S330: before the backup is formally performed, the mobile terminal first checks a network condition. The mobile terminal backs up the data to the server side preferentially through a WiFi network. If the WiFi network is unavailable, then the mobile terminal needs to prompt the user that the WiFi network is unavailable, and inquire of the user about whether to back up the data through a data network. If the data network is also unavailable, then the backup process is interrupted, and step S380 will be performed.

The backup operation may be set by the user to be automatically performed when the WiFi network is started to be available. The mobile terminal checks whether the WiFi network is available at a fixed time point (a time point at which the user starts the function). If it is available, the data is automatically backed up. In the automatic backup process, backup is only performed for the data types which are set by the user in the setting option to be backed up.

Step S340: the mobile terminal is connected to the server side, to update information about a user capacity and a growth rate, information with regard to the files which have already been backed up is synchronized, and the files are packed.

In the present embodiment, users include normal users and premium users. In an example, a usage space of 1 G is provided to a normal user, which has a growth rate of 0, while in addition to the usage space of 1 G, a capacity of 4 G is provided to a premium user. In addition, if a premium user is always in a usage state, its user capacity will grow at a rate of 1K per second.

With respect to a file having the image type and/or the video type, the mobile terminal is connected to the server side, to synchronize the information of files which have already been backed up, and those files which have already been backed up will not be upload. In the present embodiment, uniqueness of a file is determined based on MD5 values and its original path. If two files have a same MD5 value but different original paths, the files should be considered as different files, and will not be uploaded repeatedly in the backup process, but should be counted in the backup capacity;

With respect to a file having the short message type, the call record type, and/or the personal contact type, all of them are packed into a data package, and are combined and de-duplicated by the server side.

Step S350: a first capacity of the data to be backed up by the user is calculated, and a second residual user capacity at the server side is detected.

Various approaches for calculating capacities of the backed-up data having different types includes: with respect to the image type, the capacity is calculated based on file sizes with a minimal unit of 1 KB, wherein if there are repeated files, the capacity needs to be calculated repeatedly; with respect to the video type, the capacity is calculated based on file sizes with a minimal unit of 1 KB, wherein if there are repeated files, the capacity needs to be calculated repeatedly; with respect to the personal contact type, the capacity calculated based on the length of text information therein with a minimal unit of 1 KB; and with respect to the short message type and the call record type, the capacity is calculated based on the length of text information therein with a minimal unit of 1 KB.

Step S360: the first capacity is compared with the second residual user capacity to determine whether the first capacity is greater than the second residual user capacity, and if so, the backup process is interrupted, and step S380 is performed; otherwise, step S370 is performed.

Step S370: the data to be backed up is encrypted and uploaded to a database on the server side for backup, and a backup result is displayed after the backup is completed. In this embodiment, the data of the mobile terminal is encrypted and stored in a self-built database, and therefore before the data is encrypted and uploaded, the data needs to be decrypted. In the process of uploading the data, the data to be backed up may be encrypted with the HTTPS protocol, and a progress bar representing “the data is being encrypted” is displayed on the mobile terminal. After the encryption is completed, a progress bar representing “the data is being backed up” is displayed, and the data starts to be uploaded to the server side.

The server side receives an instruction of requesting for data backup from the mobile terminal, and receives the data uploaded by the mobile terminal. After the uploaded data is received, the server side needs to process and store the data.

With respect to a file having the image type and/or the video type, an incremental backup processing approach is as follows. Uniqueness of the file is determined based on its MD5 value and its original path. If two files have a same MD5 value but different original paths, the files should be considered as different files, and the server side encrypts and stores the combined data to be backed up in the database.

With respect to a file having the short message type and the call record type, an incremental backup processing approach is as follows. The server side performs combination and de-duplication processes. For a short message and/or a call record, any difference in any field indicates different records.

With respect to a file having the personal contact type, an incremental backup processing approach is as follows. The server side performs combination and de-duplication processes. Combining rules are as follows:

if two contacts have a same name and a same telephone number, they are considered as a same contact, and they are not updated;

if two contacts have a same name but different telephone numbers, a new personal contact is created; and

if two contacts have different names but a same telephone number, the original contact with the same number is overwritten.

It should be noted that with respect to the data package having the short message type, the call record type, and/or the personal contact type which is packed and uploaded by the mobile terminal, the data package is first unpacked by the server side to the original data, and is combined and de-duplicated together with existing data having the same type(s) on the server side, and then the server side packs, encrypts, and stores the combined data to be backed up in the database.

In the backup process, the backup process may be cancelled by the user at any time. For example, the backup process may be cancelled by clicking on a cancel button or clicking on a return key. If a part of files have been backed up, after the cancellation, a result of a size of data which has been backed up should be displayed. A situation where a part of a file has been successfully backed up does not exist. In addition, as the data having the short message type, the call record type, and/or the personal contact type is packed and then backed up as a whole, the packed data should be considered as one file.

In the backup process, breakpoint resume is supported. If the user cancels the backup process or the backup process is interrupted temporarily due to network conditions, the backup process should be paused. If the user chooses to continue the backup, the backup continues from a point at which the data has just been backed up, rather than starting from the very beginning. There is no need to support breakpoint resume for a single file.

In the backup process, if the user presses the HOME key to switch to another application program, the backup process will not be interrupted. When it is switched back to the backup operation, the backup process should still be displayed.

After the data has been uploaded and backed up completely, a backup result is displayed by the mobile terminal. It is only needed to display a total size of the uploaded data and sizes for various data types, without displaying a specific number of files which have been backed up.

Step S380: the backup process is interrupted, and the data backup operation ends.

In this embodiment, data backup is a measure for security protection of user's personal information, and may be manually operated by a user or may also be configured as an automatic backup.

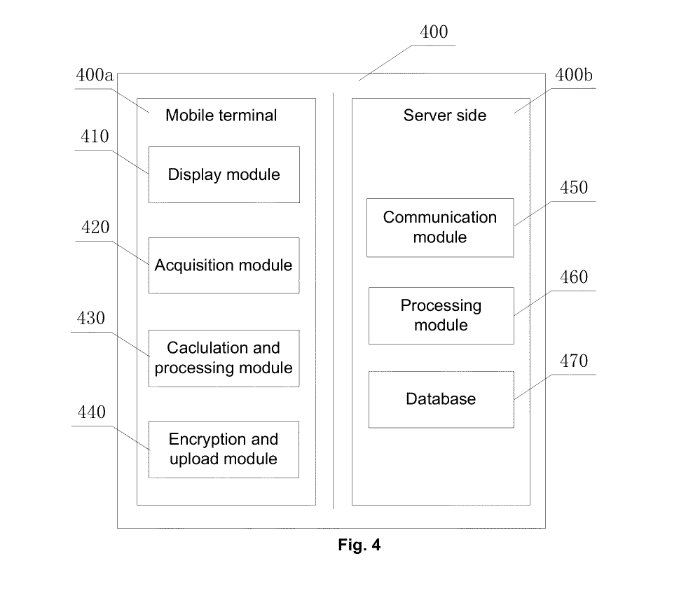

With reference to FIG. 4, illustrated is a block diagram of a data backup system 400 according to this embodiment. The system 400 includes a mobile terminal 400a and a server side 400b. The mobile terminal 400a includes a display module 410 configured to display a backup result after the backup is completed; an acquisition module 420 configured to receive a data type of data which is selected by a user to be backed up; a calculation and processing module 430 configured to calculate a first capacity of data having the same data type, detect a second residual user capacity on the server side 400b, and compare the first capacity with the second capacity; and an encryption and upload module 440 configured to encrypt and upload the data to be backed up to a database 470 on the server side 400b for backup.

The server side 400b includes a communication module 450 configured to receive an instruction of requesting for data backup from the mobile terminal 400a, and receive the data uploaded by the mobile terminal 400a; and the database 470 configured to store the data to be backed up.

With respect to a file having the image type and/or the video type, the mobile terminal 400a is connected to the server side 400b, and therefore the acquisition module 420 may acquire file information from the server side 400b, to synchronize the information of files which have already been backed up.

The data of the mobile terminal 400a is encrypted and stored in a self-built database, and therefore before the data to be backed up is encrypted and uploaded for backup, the calculation and processing module 430 needs to decrypt the data, and then also needs to pack all files having the short message type, the call record type, and/or the personal contact type into a data package(s). In the process of uploading the data, the data to be backed up is encrypted by the calculation and processing module 430 through the HTTPS protocol.

In this embodiment, a data type which may be selected by the user include but not limited to image, video, short message, call record, and/or personal contact. A personal contact includes a contact name, a telephone number(s), and/or a personal incoming call processing manner.

The system 400 is further configured to continue the backup from a point at which the data has just been backed up if the user chooses to continue the backup after the backup process is interrupted. In an embodiment of the present disclosure, breakpoint resume is supported in the backup process. If the user cancels the backup process or the backup process is interrupted temporarily due to network conditions, the backup process should be paused. If the user chooses to continue the backup, the backup continues from a point at which the data has just been backed up, rather than starting from the very beginning. There is no need to support breakpoint resume for a single file.

The server side 400b further comprises a processing module 460 configured to process the uploaded data to be backed up.

For example, with respect to a file having the image type and/or the video type, an incremental backup processing approach is as follows. Uniqueness of the file is determined based on its MD5 value and its original path. If two files have a same MD5 value but different original paths, the files should be considered as different files, and the processing module 460 combines the data to be backed up, and encrypts and stores the combined data to be backed up in the database 470.

With respect to a file having the short message type and the call record type, an incremental backup processing approach is as follows. The processing module 460 performs combination and de-duplication processes. For a short message and/or a call record, any difference in any field may indicate different records. With respect to a file having the personal contact type, an incremental backup processing approach is as follows. The processing module 460 performs combination and de-duplication processes. Combining rules are as follows:

if two contacts have a same name and a same telephone number, they are considered as a same contact, and the contacts are not updated;

if two contacts have a same name but different telephone numbers, a new personal contact is created; and

if two contacts have different names but a same telephone number, the original contact with the same number is overwritten.

It should be noted that with respect to the data package(s) having the short message type, the call record type, and/or the personal contact type which is packed and uploaded by the mobile terminal 400a, the data package(s) is firstly unpacked by the processing module 460 into the original data, and is combined and de-duplicated together with existing data having the same type(s) on the server side 400b, and then the processing module 460 packs, encrypts, and stores the combined data to be backed up in the database 470.

The above specific embodiments further describe the objects, technical solutions and beneficial effects of the present disclosure in detail. It should be understood that the above description is merely specific embodiments of the present disclosure, rather than limitations to the scope of the present disclosure. Any modification, equivalent substitution, improvement etc., made within the spirit and principle of the present disclosure, should be included in the scope of the present disclosure.

1. A data backup method, comprising:
A. receiving a data type of data which is selected by a user to be backed up;
B. calculating a first capacity of data having the same data type, detecting a second residual user capacity on a server side, and comparing the first capacity with the second capacity, wherein if the first capacity is greater than the second capacity, the backup process is interrupted, and if the first capacity is not greater than the second capacity, step C is performed; and
C. encrypting and uploading the data to be backed up to a database on the server side for backup, and displaying a backup result after the backup is completed.

2. The method according to claim 1, wherein the data type comprises any one of image, video, short message, call record, and personal contact, or any combination thereof, and wherein a personal contact comprises a contact name, a telephone number, and a personal incoming call processing manner.

3. The method according to claim 1, wherein the server side receives an instruction of requesting for data backup from the mobile terminal, and receives data uploaded by the mobile terminal.

4. The method according to claim 1, further comprising: after the backup process is interrupted, if the user chooses to continue the backup, continuing the backup from a point where the data has been backed up.

5. The method according to claim 2, further comprising: processing, by the server side, the uploaded data to be backed up by:
combining, de-duplicating, encrypting, and storing data having the image type and/or the video type; and
unpacking, combining, de-duplicating, packing, encrypting, and storing data having the short message type, the call record type, and/or the personal contact type.

6. A data backup system comprising a display module, the system further comprising: a mobile terminal comprising an acquisition module, a calculation and processing module, and an encryption and upload module; and a server side comprising a database, wherein
the acquisition module is configured to receive a data type of data which is selected by a user to be backed up;
the calculation and processing module is configured to calculate a first capacity of data having the same data type, configured to detect a second residual user capacity on the server side, and configured to compare the first capacity with the second capacity, wherein if the first capacity is greater than the second capacity, the backup process is interrupted, and if the first capacity is not greater than the second capacity, a backup operation is performed by the encryption and upload module; and
the encryption and upload module is configured to encrypt and upload the data to be backed up to the database on the server side for backup;
the display module is configured to display a backup result after the backup is completed; and
the database is configured to store the data to be backed up.

7. The system according to claim 6, wherein the data type comprises any one of image, video, short message, call record, and personal contact, or any combination thereof, and wherein a personal contact comprises a contact name, a telephone number, and a personal incoming call processing manner.

8. The system according to claim 6, wherein the server side comprises a communication module configured to receive an instruction of requesting for data backup from the mobile terminal, and configured to receive data uploaded by the mobile terminal.

9. The system according to claim 6, wherein the system is further configured to continue the backup from a point where the data has been backed up if the user chooses to continue the backup after the backup process is interrupted.

10. The system according to claim 7, wherein the server side further comprises a processing module configured to process the uploaded data to be backed up by:
combining, de-duplicating, encrypting, and storing data having the image type and/or the video type; and
unpacking, combining, de-duplicating, packing, encrypting, and storing data having the short message type, the call record type, and/or the personal contact type.
